(19) United States
(12) Patent Application Publication
(10) Pub. No.: US 2013/0252573 A1
(43) Pub. Date: Sep. 26, 2013

(54) Emergency Call Access Method and System, Base Station, and Terminal

(71) Applicant: Huawei Technologies Co., LTD, Shenzhen (CN)

(72) Inventors: Zhenqi Dong, Chengdu (CN); Zhiyu Xiao, Chengdu (CN)

(73) Assignee: Huawei Technologies Co., LTD, Shenzhen (CN)

(21) Appl. No.: 13/896,168

(22) Filed: May 16, 2013

Related U.S. Application Data
(63) Continuation of application No. PCT/CN2012/071389, filed on Feb. 21, 2012.

(51) Int. Cl. H04W 4/22

(52) U.S. Cl. CPC H04W 4/22
USPC 455/404.1

(57) ABSTRACT

The present invention provides a call access method, device and system. A base station receives a call access request sent by a terminal. The call access request includes a type of a call that the terminal requests accessing. The base station performs uplink synchronization with the terminal. The base station receives capability information of the terminal and sends a reception acknowledgement response to the capability information to the terminal. If the type of the call is an emergency call, the base station directly sends configuration information of a default bearer that corresponds to the capability information to the terminal.

### CROSS-REFERENCE TO RELATED APPLICATIONS

This application is a continuation of International Application No. PCT/CN2012/071389, filed on Feb. 21, 2012, which is hereby incorporated by reference in its entirety.

### TECHNICAL FIELD

Embodiments of the present invention relate to communications technologies, and in particular, to an emergency call access method and system, a base station, and a terminal.

### BACKGROUND

When life or property of a user are threatened or attacked, an emergency call can be initiated by dialing an alarm or emergency number, such as 112, 110, 119, or 120, through a terminal (also called user equipment, referred to as UE). In the prior art, a random access procedure of an emergency call is the same as a random access procedure of a non-emergency call. For example, a random access procedure of an existing emergency call in a long term evolution (LTE) system is the same as a random access procedure of a voice over Internet protocol (VoIP) service. A complete random access procedure includes sub-procedures such as RRC connection setup, UE capability enquiry, security mode configuration, and default bearer resource reconfiguration. In a security mode configuration sub-procedure, an evolved node B (eNB) sets, according to a UE capability, a security algorithm used for performing access authentication for the UE, and sends configuration information of the security algorithm to the UE through a security mode command; the UE performs security mode configuration according to the configuration information of the security algorithm, and then feeds back a security mode complete (for example, Security Mode Command) message to the eNB; and the eNB returns an acknowledgement (ACK) message to the UE. After the security mode configuration sub-procedure is completed, the eNB configures a default bearer for the UE through a default bearer resource reconfiguration sub-procedure, so that an emergency call initiated by the UE is accessed through the default bearer.

A difference between an emergency call and an ordinary call is the urgency of the call, so each country has similar provisions to give priority to protect the reliability of emergency call access. For example, it is required that normal access of an emergency call can also be ensured under scenarios that a UE charge is overdue, a UE is suspended, a UE is located in a network coverage range of a non-home operator, and a SIM card is not inserted in a UE. That is to say, a network side device does not need to perform access authentication for a UE that initiates an emergency call, and an eNB does not need to configure a security algorithm required for the access authentication for the UE either. In the prior art, when a call initiated by the UE is an emergency call, configuration information of a security algorithm in a security mode command message sent by the eNB to the UE is set to null, the UE returns a security mode complete message to the eNB, and the eNB returns an ACK message to the UE, so as to ensure the integrity of a random access procedure of the emergency call.

However, because in an existing random access procedure of an emergency call, a security mode configuration sub-procedure still needs to be executed, an access delay of the emergency call is relatively long.

### SUMMARY OF THE INVENTION

Embodiments of the present invention provide an emergency call access method and system, a base station, and a terminal, so as to reduce an access delay and a signaling overhead that are required for an emergency call.

In one aspect, the present invention provides a call access method, including receiving, by a base station, a call access request sent by a terminal, where the call access request includes a type of a call that the terminal requests accessing, performing, by the base station, uplink synchronization with the terminal, receiving, by the base station, capability information of the terminal, and sending a reception acknowledgement response to the capability information to the terminal, and if the type of the call is an emergency call, directly sending, by the base station, configuration information of a default bearer that corresponds to the capability information to the terminal.

In another aspect, the present invention further provides another emergency call access method, including sending, by a terminal, a call access request to a base station, where the call access request includes a type of a call that the terminal requests accessing, performing, by the terminal, uplink synchronization with the base station, sending, by the terminal, capability information of the terminal to the base station, and receiving a reception acknowledgement response to the capability information, where the reception acknowledgement response is sent by the base station, and if the terminal does not receive, within a preset duration after receiving the reception acknowledgement response, a security mode command sent by the base station, accessing, by the terminal, the call based on configuration information of a default bearer that corresponds to the capability information, where the configuration information is received from the base station.

In another aspect, the present invention further provides a base station, including a receiver, a processor, and a sender, where the receiver is configured to receive a call access request sent by a terminal and capability information of the terminal, the processor is configured to: when the receiver receives the call access request sent by the terminal, perform uplink synchronization with the terminal, determine whether the call access request includes a type of a call that the terminal requests accessing, and if yes, trigger the sender, and the sender is configured to: when the receiver receives the capability information of the terminal, send a reception acknowledgement response to the capability information to the terminal, and when a trigger of the processor is received, directly send configuration information of a default bearer that corresponds to the capability information to the terminal.

In another aspect, the present invention further provides a terminal, including a sender, a processor, a timer, and a receiver, where the sender is configured to: send a call access request to a base station, where the call access request includes a type of a call that the terminal requests accessing, and after the processor performs uplink synchronization with the base station, send capability information of the terminal to the base station, the processor is configured to: after the sender sends the call access request to the base station, perform uplink synchronization with the base station, the receiver is configured to receive a reception acknowledgement response to the capability information, where the reception acknowledgement response is sent by the base station, and receive configuration information of a default bearer that corresponds to the capability information, where the configuration information is sent by the base station, the timer is configured to start when the receiver receives the reception acknowledgement response, and the processor is further configured to: before the timer times out and when the receivers does not receive a security mode command sent by the base station, access the call based on the configuration information of the default bearer that corresponds to the capability information, where the configuration information is received from the base station.

In another aspect, the present invention further provides a call access system, including a base station, where the base station is configured to: receive a call access request sent by a terminal, where the call access request includes a type of a call that the terminal requests accessing; perform uplink synchronization with the terminal; receive capability information of the terminal and send a reception acknowledgement response to the capability information to the terminal; and when the type of the call is an emergency call, directly send configuration information of a default bearer that corresponds to the capability information to the terminal.

In the foregoing technical solutions, if a type of a call that a terminal requests accessing is an emergency call, in view of a characteristic of an emergency call service, an existing access control procedure of an ordinary service is optimized, thereby reducing an access delay of the emergency call.

### BRIEF DESCRIPTION OF THE DRAWINGS

To describe the technical solutions in the embodiments of the present invention or in the prior art more clearly, the accompanying drawings required for describing the embodiments are briefly introduced in the following. Apparently, the accompanying drawings in the following description show merely some embodiments of the present invention, and persons of ordinary skill in the art may still derive other drawings from these accompanying drawings without creative efforts.

FIG. 1 is a flow chart of an emergency call access method according to an embodiment of the present invention;

FIG. 2 is a flow chart of another emergency call access method according to an embodiment of the present invention;

FIG. 3 is a signaling interaction diagram of a random access method for an emergency call in an LTE system according to an embodiment of the present invention;

FIG. 4 is a schematic structural diagram of a base station according to an embodiment of the present invention;

FIG. 5 is a schematic structural diagram of a terminal according to an embodiment of the present invention; and

FIG. 6 is a schematic structural diagram of an emergency call access system according to an embodiment of the present invention.

### DETAILED DESCRIPTION OF ILLUSTRATIVE EMBODIMENTS

To make the objectives, technical solutions, and advantages of the embodiments of the present invention more comprehensible, the technical solutions in the embodiments of the present invention are described clearly in the following with reference to the accompanying drawings in the embodiments of the present invention. Apparently, the embodiments to be described are merely a part rather than all of the embodiments of the present invention. All other embodiments obtained by persons of ordinary skill in the art based on the embodiments of the present invention without creative efforts shall fall within the protection scope of the present invention.

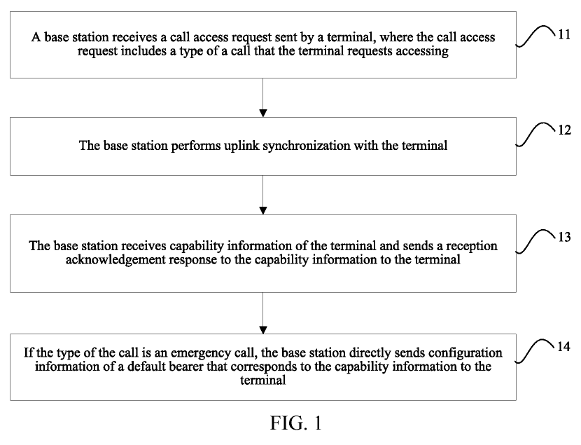

FIG. 1 is a flow chart of an emergency call access method according to an embodiment of the present invention. As shown in FIG. 1, the method includes the following steps.

11: A base station receives a call access request sent by a terminal, where the call access request includes a type of a call that the terminal requests accessing.

A type of a call initiated by a terminal may include: an emergency call and a non-emergency call. The terminal sends a call access request to a base station to request the base station to allocate a resource that is required for current call access of the terminal.

12: The base station performs uplink synchronization with the terminal.

13: The base station receives capability information of the terminal and sends a reception acknowledgement response to the capability information to the terminal.

14: If the type of the call is an emergency call, the base station directly sends configuration information of a default bearer that corresponds to the capability information to the terminal.

If the type of the call is an emergency call, the base station sends configuration information of the default bearer that corresponds to the capability information to the terminal, and before sending the configuration information to the terminal, does not send a security mode command to the terminal. The configuration information is applied when configuration of the default bearer is performed in a terminal call access process.

If the type of the call is a non-emergency call, such as a VoIP service, before sending the configuration information of the default bearer to the terminal, the base station needs to perform security mode configuration according to the capability information of the terminal and perform related interaction of the security mode configuration with the terminal, so as to determine information such as a security algorithm that needs to be used by a core network to perform access authentication on the terminal. For example, when the type of the call is a non-emergency call, the base station sends a security mode command to the terminal to notify the terminal of a security algorithm that needs to be used in access authentication, and after receiving a complete message that is returned by the terminal based on the security mode command, sends the configuration information of the default bearer to the terminal.

In this embodiment, in a process that a base station performs call access control, if a type of a call that a terminal requests accessing is an emergency call, in view of a characteristic of an emergency call service, an existing access control procedure is optimized. For example, for a characteristic that a core network does not need to perform authentication for an emergency call service, related signaling interaction about a security mode between the base station and the terminal in the existing access control procedure is omitted, and configuration information of a default bearer is directly sent to the terminal for the access of the call of the terminal, where the access is based on the default bearer that corresponds to the configuration information, thereby reducing an access delay of the emergency call, and saving a signaling overhead required for related interaction of security mode configuration; and it is also beneficial to reducing a probability of an emergency call access failure that is caused by a failure of the related interaction of the security mode configuration.

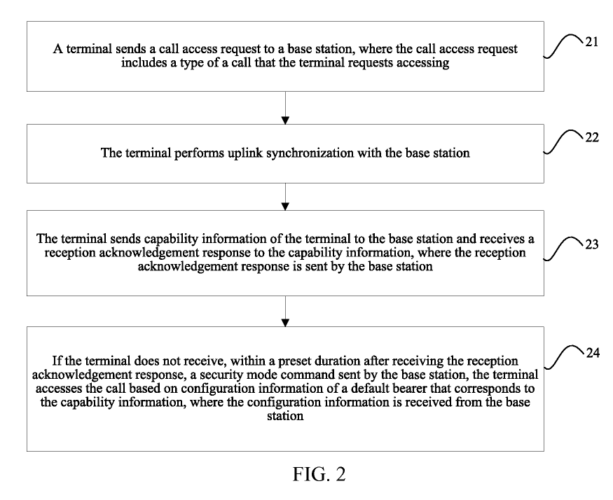

FIG. 2 is a flow chart of another emergency call access method according to an embodiment of the present invention. As shown in FIG. 2, the method includes the following steps.

21: A terminal sends a call access request to a base station, where the call access request includes a type of a call that the terminal requests accessing.

A type of a call initiated by a terminal may include: an emergency call and a non-emergency call. The terminal sends a call access request to the base station to request the base station to allocate a resource that is required for current call access of the terminal.

22: The terminal performs uplink synchronization with the base station.

23: The terminal sends capability information of the terminal to the base station and receives a reception acknowledgement response to the capability information, where the reception acknowledgement response is sent by the base station.

24: If the terminal does not receive, within a preset duration after receiving the reception acknowledgement response, a security mode command sent by the base station, the terminal accesses the call based on configuration information of a default bearer that corresponds to the capability information, where the configuration information is received from the base station.

For a normal call access procedure, after acquiring the capability information of the terminal, the base station needs to perform security mode configuration according to the capability information of the terminal and perform related interaction of security mode configuration with the terminal, so as to determine information such as a security algorithm that needs to be used by a core network to perform access authentication on the terminal; after the security mode configuration is completed, the base station delivers the configuration information of the default bearer to the terminal. Therefore, in the normal call access procedure, before receiving the configuration information of the default bearer, where the configuration information of the default bearer is delivered by the base station, the terminal needs to complete the related interaction of the security mode configuration between the terminal and the base station; otherwise, the terminal considers that call access is faulty and further determines that the access of the call fails.

In this embodiment, a particularity that a core network does not need to perform access authentication on an emergency call is considered and optimization processing is performed on the foregoing normal call access procedure for the emergency call. For example, in an access process of an emergency call of the terminal, if the terminal receives the reception acknowledgement response, and within the preset duration, does not receive the security mode command sent by the base station, the terminal does not directly determine that the access of a call fails, but performs consideration in combination with a type of the call that the terminal currently requests accessing, that is, when the call that the terminal currently requests accessing is an emergency call, the call is accessed based on a default bearer that corresponds to the configuration information; otherwise, it is determined that the access of the call fails.

After an emergency call access procedure undergoes the foregoing optimization processing, related signaling interaction about security mode configuration between a base station and a terminal in an existing access control procedure is omitted, thereby reducing an access delay of an emergency call, and saving a signaling overhead required for the related signaling interaction of the security mode configuration; and it is also beneficial to reducing a probability of an emergency call access failure that is caused by a failure of the related interaction of the security mode configuration.

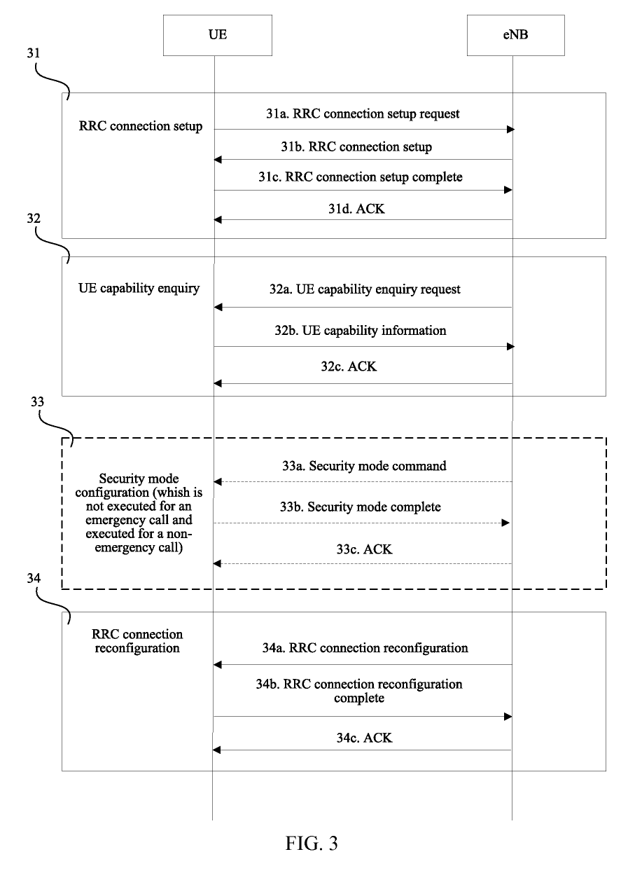

The solution provided in this embodiment of the present invention is applicable to various systems. In the following, the technical solution and effect in this embodiment of the present invention are further described by taking an LTE system as an example. FIG. 3 is a signaling interaction diagram of a random access method for an emergency call in an LTE system according to an embodiment of the present invention. As shown in FIG. 3, an emergency call access method includes three sub-procedures: radio resource control (Radio Resource Control, RRC) connection setup, UE capability enquiry, and RRC connection reconfiguration.

31: A UE and an eNB perform related interaction of RRC connection setup. 31 may include 31a to 31d.

31a: The UE sends an RRC connection setup request (RRC Connection Request) to the eNB to request the eNB to allocate a resource that is required for current call access of the UE, where the RRC connection setup request includes a type of a call that the UE requests accessing currently.

In this embodiment, the type of the call that the UE requests accessing currently is an emergency call.

31b: The eNB sends an RRC connection setup (RRC Connection Setup) message to the UE.

The RRC connection setup message is used for instructing the UE to perform uplink synchronization with the eNB and establishing a signaling radio bearer (SRB), and so on.

31c: The UE sends an RRC connection setup complete message to the eNB.

31d: The eNB sends an ACK to the UE.

32: The eNB and the UE perform related interaction of UE capability enquiry, so as to enable the eNB to acquire capability information of the UE. 32 may include 32a to 32c.

32a: The eNB sends a UE capability enquiry request to the UE.

32b: The UE sends UE capability information to the eNB.

32c: The eNB sends an ACK to the UE.

After 32c is executed, according to the RRC connection setup request, the eNB may determine the type of the call that the UE requests accessing currently. If the type of the call that the UE requests accessing currently is an emergency call, a security mode configuration sub-procedure 33 in a random access procedure of a non-emergency call is skipped, and an RRC connection reconfiguration sub-procedure 34 is directly executed.

34: The eNB and the UE perform related interaction of RRC connection reconfiguration. 34 may include 34a to 34c.

34a: When the eNB determines, according to the RRC connection setup request, that the type of the call that the UE requests accessing currently is an emergency call, the eNB sends an RRC connection reconfiguration message to the UE, where the RRC connection reconfiguration message includes configuration information of a default bearer that corresponds to capability information of a terminal.

The configuration information of the default bearer may include, but is not limited to, one or any combination of the following information: a logic channel, a logic channel group, and radio link quality of service (QoS) of a default bearer that is allocated by the eNB to the UE according to the capability information of the UE.

34b: When the type of the call that the UE requests accessing currently is an emergency call, the UE sends an RRC connection reconfiguration complete message to the eNB.

34c: The eNB sends an ACK to the UE.

If the type of the call that the UE requests accessing currently is a non-emergency call, after 32c is executed, related interaction of security mode configuration 33, indicated by a dotted line in FIG. 3, needs to be performed between the eNB and the UE, and then the RRC connection reconfiguration sub-procedure 34 is executed.

Because of a particularity of an emergency call, a core network side does not perform security authentication such as access authentication on a UE that initiates an emergency call, but directly gives the go-ahead. It can be seen that, the eNB does not need to perform security mode configuration, which is required for access authentication, for the UE. In this embodiment, the particularity of the emergency call is considered, simplifying processing is performed on a random access procedure of the emergency call, and related interaction process of security mode configuration is omitted, so as to save a signaling overhead and reduce a delay required for call access.

The security mode configuration sub-procedure indicated by the dotted line in FIG. 3 is related interaction of security mode configuration, where the related interaction of the security mode configuration is performed by the eNB and the UE in a pre-scheduling scenario, that is, a scenario where the eNB actively allocates a pre-scheduling resource to the UE in advance; and mainly includes 33a to 33c.

33a: The eNB sends a security mode command to the UE.

33b: The UE may send a security mode complete message to the eNB based on the pre-scheduling resource.

34c: The eNB sends an ACK to the UE.

By considering a base band processing delay and transmission delay, about 4 ms is required from sending of every piece of signaling to receiving and processing of every piece of signaling, and about 2 ms is required from sending of an ACK to receiving of the ACK by the UE, and therefore, about 10 ms is required in total for the eNB and the UE to perform the related interaction of the security mode configuration described in 33a to 33c. In this embodiment, in an emergency call access procedure, the related interaction of the security mode configuration described in 33a to 33c is omitted, so that a delay of about 10 ms in a call access procedure may be reduced, and meanwhile, a signaling overhead required for sending a security mode command and a security mode complete message is saved.

If in a non-pre-scheduling scenario, that is, in a scenario where the eNB does not allocate a pre-scheduling resource to the UE, the UE needs to send feedback information to the eNB and needs to acquire uplink grant of the eNB. For example, the UE needs to send a schedule request indication (SRI) message to the eNB; after receiving the SRI message, the eNB may allocate, to the UE, a resource for reporting a security mode complete message, and notifies the UE through an uplink grant (UL Grant) message. Related interaction of uplink grant needs about 8 ms. It can be seen that, in a non-pre-scheduling scenario, after simplifying processing is performed on the emergency call access procedure by using the technical solution provided in this embodiment, a delay of about 10 ms+8 ms=18 ms may be reduced, and meanwhile, a signaling overhead required for sending a security mode command, a security mode complete message, a scheduling request indication, and an uplink grant message is saved.

It should be noted that, for brevity, the foregoing method embodiments are described as a series of actions. However, persons skilled in the art should know that the present invention is not limited to the order of the described actions, because according to the present invention, some steps may adopt other order or occur simultaneously. Next, persons of ordinary skill in the art may know that the embodiments described in this specification all belong to exemplary embodiments and the involved actions and modules are not necessarily required in the present invention.

In the foregoing embodiments, the descriptions of the embodiments have respective focuses. For a part that is not described in detail in a certain embodiment, reference may be made to related descriptions in other embodiments.

Persons of ordinary skill in the art may understand that all or a part of the steps of the method embodiments may be implemented by a program instructing relevant hardware. The program may be stored in a computer readable storage medium. When the program is run, the steps of the method embodiments are performed. The storage medium may be any medium that is capable of storing program codes, such as a read-only memory (ROM), a random access memory (RAM), a magnetic disk, or an optical disk.

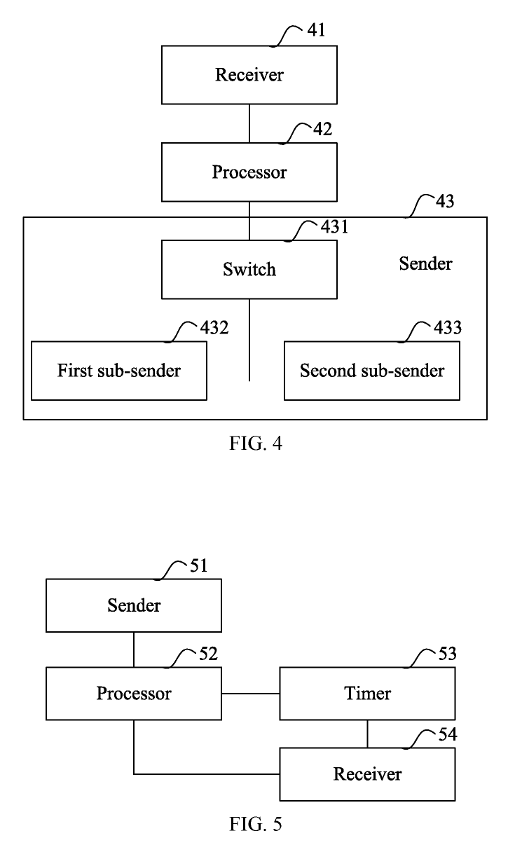

FIG. 4 is a schematic structural diagram of a base station according to an embodiment of the present invention. The base station provided in this embodiment is configured to implement the method shown in FIG. 1. For example, as shown in FIG. 4, the base station includes: a receiver 41, a processor 42, and a sender 43.

The receiver 41 may be configured to receive a call access request sent by a terminal and capability information of the terminal.

The processor 42 is configured to: when the receiver 41 receives the call access request sent by the terminal, perform uplink synchronization with the terminal, determine whether the call access request includes a type of a call that the terminal requests accessing, and if yes, trigger the sender 43. The type of the call that the terminal requests accessing is an emergency call.

The sender 43 is configured to: when the receiver 41 receives the capability information of the terminal, send a reception acknowledgement response to the capability information to the terminal, and when a trigger of the processor 42 is received, directly send configuration information of a default bearer that corresponds to the capability information to the terminal. The configuration information is applied when configuration of the default bearer is performed in a terminal call access process.

Optionally, the sender 43 may include a switch 431, a first sub-sender 432, and a second sub-sender 433.

The switch 431 is configured to: when the trigger of the processor 42 is received, connect to the second sub-sender 433, where the switch 431 does not simultaneously connect to the first sub-sender 432. When the trigger of the processor 42 is not received, the switch 431 may connect to the first sub-sender 432.

The first sub-sender 432 is configured to: when connecting to the switch 431, send the configuration information of the default bearer that corresponds to the capability information to the terminal.

The second sub-sender 433 is configured to: when connecting to the switch 431, send a security mode command to the terminal.

In this embodiment, in a process that a base station performs call access control, if a type of a call that a terminal requests accessing is an emergency call, related signaling interaction about security mode configuration between the base station and the terminal in an existing access control procedure is omitted, and configuration information of a default bearer is directly sent to the terminal, so that the terminal accesses the call based on the default bearer that corresponds to the configuration information, thereby reducing an access delay of the emergency call, and saving a signaling overhead required for related interaction of security mode configuration; and it is beneficial to reducing a probability of an emergency call access failure that is caused by a failure of the related interaction of the security mode configuration. For a working mechanism of the base station in this embodiment, reference may be made to the description about the eNB in FIG. 1 and FIG. 3, which is not described herein again.

FIG. 5 is a schematic structural diagram of a terminal according to an embodiment of the present invention. The terminal provided in this embodiment is configured to implement the method shown in FIG. 2. For example, as shown in FIG. 5, the terminal include: a sender 51, a processor 52, a timer 53, and a receiver 54.

The sender 51 is configured to: send a call access request to a base station, where the call access request includes a type of a call that the terminal requests accessing, and after the processor performs uplink synchronization with the base station, send capability information of the terminal to the base station.

The processor 52 is configured to: after the sender sends the call access request to the base station, perform uplink synchronization with the base station.

The receiver 54 is configured to receive a reception acknowledgement response to the capability information, where the reception acknowledgement response is sent by the base station, and receive configuration information of a default bearer that corresponds to the capability information, where the configuration information is sent by the base station. In an optional implementation manner, the receiver 54 may be specifically configured to: receive the reception acknowledgement response, and when the reception acknowledgement response is received and a security mode command sent by the base station is not received before the timer times out, receive the configuration information of the default bearer.

The timer 53 is configured to start when the receiver 54 receives the reception acknowledgement response.

The processor 52 is further configured to: before the timer 53 times out and when the receivers 54 does not receive the security mode command sent by the base station, access the call based on the configuration information of the default bearer that corresponds to the capability information, where the configuration information is received from the base station.

In this embodiment, in an access process of an emergency call of a terminal, if it is determined that a base station receives capability information of the terminal but a security mode configuration command sent by the base station is not received, when the terminal receives configuration information of a default bearer sent by the base station, the terminal does not directly determine that access of the call fails, but performs consideration in combination with a type of a call that the terminal currently requests accessing, that is, when the call that the terminal currently requests accessing is an emergency call, the call is accessed based on the default bearer that corresponds to the configuration information; otherwise, it is determined that the access of the call fails, thereby reducing an access delay of the emergency call, and saving a signaling overhead required for related interaction of security mode configuration; and it is beneficial to reducing a probability of an emergency call access failure that is caused by a failure of the related interaction of the security mode configuration. For a working mechanism of the terminal in this embodiment, reference may be made to the description about the UE in FIG. 2 and FIG. 3, which is not described herein again.

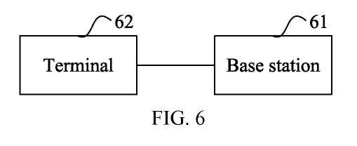

FIG. 6 is a schematic structural diagram of an emergency call access system according to an embodiment of the present invention. As shown in FIG. 6, the system includes a base station 61. The base station 61 is configured to: receive a call access request sent by a terminal, where the call access request includes a type of a call that the terminal requests accessing; perform uplink synchronization with the terminal; receive capability information of the terminal and send a reception acknowledgement response to the capability information to the terminal; and when the type of the call is an emergency call, directly send configuration information of a default bearer that corresponds to the capability information to the terminal.

Optionally, the system may further include a terminal 62. The base station 61 is connected to the terminal 62 in a communication manner. The terminal 62 is configured to access the call based on the default bearer that corresponds to the configuration information.

In this embodiment, for a detailed structure of the base station 61, reference may be made to the description in the embodiment corresponding to FIG. 4, and for a working mechanism and an achievable technical effect of the base station 61, reference may be made to the description about the eNB in FIG. 1 and FIG. 3; for a detailed structure of the terminal 62, reference may be made to the description in the embodiment corresponding to FIG. 5, and for a working mechanism and an achievable technical effect of the terminal 62, reference may be made to the description about the UE in FIG. 2 and FIG. 3; and in an LTE system, for an interaction method, which is performed between the base station and the terminal, accessing an emergency call, reference may be made to the description in FIG. 3, which is not described herein again.

It may be understood that the system, the apparatus and the method disclosed in the present invention may be implemented in other manners. For example, the foregoing described apparatus embodiments are merely exemplary. For example, the module division is merely logical function division and may be other division in actual implementation. For example, a plurality of modules may be combined or integrated into another system, or some features may be ignored or may not be performed. In addition, a mutual connection between the displayed or discussed modules or apparatuses may be implemented through some physical or logical interfaces, and the connection may be in an electrical or mechanical form or in other forms.

The foregoing described apparatus embodiments are merely exemplary. The modules described as separate parts may or may not be physically separate, and parts displayed as modules may or may not be physical units, may be located in one position, or may be distributed on at least two network units. A part of or all of the modules among the at least two network units may be selected according to an actual need to achieve the objectives of the solutions in the embodiments. Persons of ordinary skill in the art may understand and implement the embodiments without creative efforts.

Finally, it should be noted that, the foregoing embodiments are merely intended for describing the technical solutions of the present invention rather than limiting the present invention. Although the present invention is described in detail with reference to the foregoing embodiments, persons of ordinary skill in the art should understood that they may still make modifications to the technical solutions described in the foregoing embodiments, or make equivalent replacements to part of the technical features of the technical solutions, as long as these modifications or replacements do not cause the essence of corresponding technical solutions to depart from the scope of the technical solutions in the embodiments of the present invention.

What is claimed is:

1. A call access method, comprising:
receiving, by a base station, a call access request from a terminal;
receiving, by the base station, capability information of the terminal;
determining, by the base station, whether the call access request carries a type of a call that the terminal requests accessing and the type of the call is an emergency call; and
sending, by the base station, configuration information of a default bearer that corresponds to the capability information to the terminal on condition that the call access request carries the type of the call that the terminal requests accessing and the type of the call is the emergency call, wherein no security mode command is sent by the base station to the terminal before the base station sending the configuration information of the default bearer to the terminal.

2. The method according to claim 1, wherein, after receiving, the call access request from the terminal, the method further comprises performing, by the base station, uplink synchronization with the terminal.

3. The method according to claim 1, wherein after receiving, the capability information of the terminal, the method further comprises sending, by the base station, a reception acknowledgement in response to the capability information to the terminal.

4. The method according to claim 1, wherein the configuration information of the default bearer is used for a configuration of the default bearer in a call access process of the terminal, wherein the call access process is an access process of the emergency call.

5. A device, comprising:
a receiver;
a processor; and
a sender;
wherein the receiver is configured to receive a call access request from a terminal and capability information of the terminal;
wherein the processor is configured to determine whether the call access request carries a type of a call that the terminal requests accessing, wherein the type of the call is an emergency call, and to trigger the sender on condition that the call access request carries the type of the call that the terminal requests accessing wherein the type of the call is an emergency call; and
wherein the sender is configured to send configuration information of a default bearer that corresponds to the capability information to the terminal upon being triggered by the processor without sending a security mode command to the terminal before sending the configuration information of the default bearer to the terminal.

6. The device according to claim 5, wherein the device further comprises a switch and the sender comprises a first sub-sender and a second sub-sender, the switch being able to connect only one of the first sub-sender or the second sub-sender at a time and being configured to connect to the second sub-sender upon being triggered by the processor, the first sub-sender being configured to send the configuration information of the default bearer that corresponds to the capability information to the terminal when being connected to the switch, and the second sub-sender being configured to send a security mode command to the terminal when being connected to the switch.

7. The device according to claim 5, wherein the processor is further configured to perform uplink synchronization with the terminal after the receiver receives the call access request from the terminal.

8. The device according to claim 5, wherein the sender is further configured to send a reception acknowledgement in response to the capability information to the terminal after the receiver receives the capability information of the terminal.

9. The device according to claim 5, wherein the configuration information of the default bearer is used for a configuration of the default bearer in a call access process of the terminal, wherein the call access process is an access process of the emergency call.

10. The device according to claim 5, wherein the device is a base station.

11. A telecommunication system, comprising a device according to claim 5.

12. The system according to claim 11, further comprising the terminal, wherein the terminal is configured to access the call based on the configuration information of the default bearer that corresponds to the capability information of the terminal.

13. A device, comprising:
a sender, configured to send a call access request and capability information of a terminal to a base station, wherein the call access request comprises a type of a call that the terminal requests accessing;
a receiver, configured to receive a reception acknowledgement from the base station, wherein the reception acknowledgement is a response to the capability information of the terminal;
a processor, configured to determine whether a security mode command is received from the base station within a duration of a timer, and to access the call based on configuration information of a default bearer that corresponds to the capability information of the terminal on condition that the processor determines that no security mode command is received from the base station within the duration of the timer; and
wherein the timer is configured to start/restart when the receiver receives the reception acknowledgement.

14. The device according to claim 13, wherein the processor is further configured to perform uplink synchronization with the base station after the sender sends the call access request to the base station.

15. The device according to claim 13, wherein the receiver is further configured to receive the configuration information of the default bearer from the base station before the processor accesses the call.

16. The device according to claim 13, wherein the processor is configured to perform a configuration of the default bear according to the configuration information of the default bearer, and access the call according to the configuration of the default bear.

17. The device according to claim 13, wherein the type of the call that the terminal requests accessing is an emergency call.
